(19) United States
(12) Patent Application Publication
(10) Pub. No.: US 2018/0263191 A1
(43) Pub. Date: Sep. 20, 2018

(54) Enclosure

(71) Applicant: Johannes Buchner, Hallein (AT)

(72) Inventor: Johannes Buchner, Hallein (AT)

(21) Appl. No.: 15/912,607

(22) Filed: Mar. 6, 2018

(30) Foreign Application Priority Data
Mar. 16, 2017 (AT) A 107/2017

(51) Int. Cl. A01G 9/02

(52) U.S. Cl. CPC A01G 9/02

(57) ABSTRACT

The invention relates to an enclosure, in particular for a plant container such as a raised bed, flower box or the like, having upright panels, wherein upright hollow corner profiles are used to support those at the corners of the enclosure, which have two formed legs on the outside in order to encompass the panels at their vertical outer edges, wherein at least one approximately horizontally extending hole for passing through a circumferential pulling means is provided in the corner profile at the inner corner and that the corner profiles are pulled together with this pulling means.

### TECHNICAL FIELD

The invention relates to an enclosure, in particular for a plant container such as a raised bed, flower box or the like, having upright panels, wherein upright hollow corner profiles are used to support those at the corners of the enclosure, which have two formed legs on the outside in order to encompass the panels at their vertical outer edges.

### BACKGROUND

Enclosures having corner posts or corner profiles and panels are known. For example, at www.betonbroz.cz. In this case, adjacent panels are bolted together with connecting parts. Overall, in this case, many connecting parts are necessary and the panels must be processed.

Furthermore, a utility model application No. 8423085.1 for securing cargo for loading areas is known. In this application however, the pulling means is not circumferential and does not connect other corner profiles. A corner profile is used, having two upright U-shaped grooves at right angles to each other, in which side walls lie and are fastened to it. In this corner profile, an undercut groove is fit in the inner corner into which the head of an eyelet can be inserted. A pulling means, which serves to secure cargo, is then pulled through the eyelet. The disadvantage in this case is the elaborately designed profile and also the unnecessarily high parts requirement.

### SUMMARY

The object of the invention is a simplification of such an enclosure, so that a simply designed corner profile can be used, very few components are needed and that the assembly is quick and easy.

These objects are achieved according to the invention by the features of claim 1.

The dependent claims relate to further advantageous embodiments of the invention.

This is achieved in that at least one approximately horizontally extending hole for the passing through of a circumferential pulling means is fit in the corner profile at the inner corner and that the corner profiles are pulled together with this pulling means.

In this case, the profile can be designed very simple, it does not need fastening parts fastened to it and the panels do not need to be processed.

The profiles pulled together with the pulling means hold the panels on the outside with their two formed legs and the weight of the filling material supports the panels on the inside. The assembly of the enclosure according to the invention is also extremely simple and fast due to this very simple design.

Conventional panels available in the building supply store, such as patio tiles, tiling and the like, can be used for the panels. These panels are made of stone material, such as granite or artificial stone such as concrete or ceramic. They are weather-resistant, stable and stiff. It can thus also be used to build a very stable and stiff enclosure, which consistently looks good over the years.

A preferred embodiment variant of the enclosure is characterized in that the inner corner of the hollow corner profile is designed arc-shaped and holes are further provided following the arc in the two walls of the inner corner of the hollow profile so that the pulling means can wrap around the arc kink-free.

Thus, the pulling means, such as a rope, can easily slide around this arc during tensioning and pass on the tensioning force well so that a uniform tension of the pulling means is achieved all around. With an edged embodiment of the hole, a kink would already occur at the beginning of the tensioning process on the pulling means and the tensioning force would not be passed on.

In another variant associated with the previous embodiment, at least one of the end pieces attached to the two ends of the pulling means is designed bent. One can thus thread the pulling means easily through the holes of the profiles inside at the corners of the enclosure after setting up the panels and corner profiles for a closed enclosure.

In a further advantageous embodiment variant of the enclosure, two U-shaped clamping parts are used for tensioning the pulling means, which are screwed together with a screw and a nut or a thread in the second clamping part.

At the clamping parts, there is, at a leg in the inner region, a hole for the screw and opposite in the second leg, a slot though which the rope passes, but the end pieces bear against. By tightening the screw, the two clamping parts are screwed together and tighten the rope.

According to a further embodiment variant of the enclosure, the panels used are made of porcelain stoneware. These are very weather-resistant and washable. If an algae growth should have arisen over the years, this can simply be washed off. Porcelain stoneware is available with different decors, such as marble, granite or wood. Enclosures with very individual appearances can thus be offered.

### BRIEF DESCRIPTION OF THE DRAWINGS

In the following, an embodiment of the enclosure according to the invention is shown schematically in the figures and further explained. It shows:

FIG. 1 a 4-edged enclosure having the set-up panels 1 with the hollow corner profiles 2 which are pulled together inside with a pulling means 7 in perspective view.

FIG. 2 an enlarged detail of the enclosure as in FIG. 1 in top view. A panel which extends parallel to the pulling means 7 has been omitted from the view to better show clamping parts 10, 11 of the pulling means.

### DETAILED DESCRIPTION

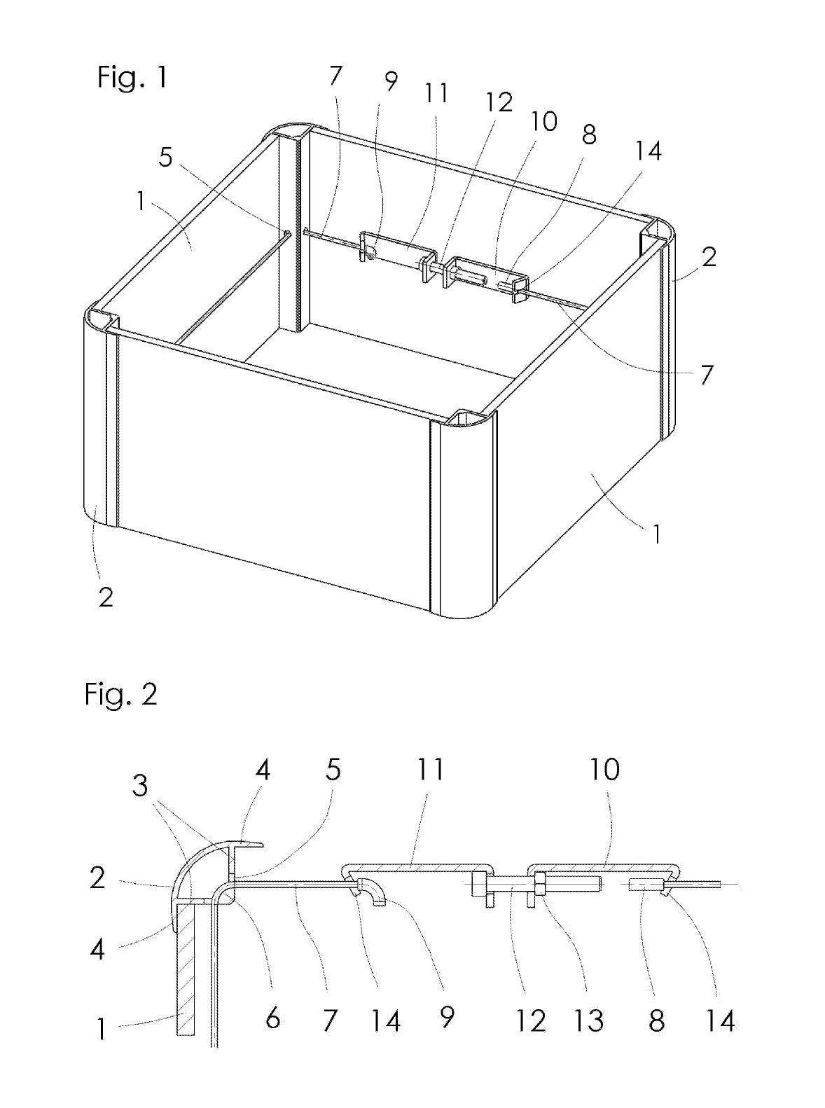

FIG. 1 and FIG. 2 show the enclosure, constructed of panels 1 with the upright hollow corner profiles 2 whose walls 3 of the corner abut the end faces of the panels 1 and the two legs 4 which support the panels 1 on the outside.

The corner profile 2 is a hollow profile advantageously manufactured extruded from an aluminum alloy. At best, a stainless steel cable 7 is used for the pulling means 7 at the ends of which compression sleeves 8 and 9 are pressed on. A compression sleeve 9 is bent therefrom. This is necessary to allow easy threading through the holes 5 of the corner profile.

In the embodiment variant shown here, the inner corner of the corner profile 2 is arc-shaped, while the holes 5 for the pulling means 7 are further provided following the arc 6 in both walls 3 of the inner corner, so that the rope 7 abuts the arc 6 and the two holes 5 inside. The holes 5 in the profile 2 can be drilled or punched out.

In FIG. 2, it can be seen how the end faces of the panels 1 abut the walls 3 of the inner corner. The walls 3 are so wide that there is still enough space for slightly thicker panels 1 and the holes 5. Two U-shaped clamping parts 10 and 11 are used for tensioning the pulling means 7. In the clamping parts 10 and 11, there is, in the first leg, a hole for the screw 12 and in the opposite second, a slot 14 in which the rope 7 passes through, but the end pieces 8 and 9 bear against. The clamping parts 10 and 11 are screwed together with a screw 12 and a nut 13 and the pulling means 7 tightens by tightening the screw 12. Instead of the nut 13, a thread may be fit in the clamping part 10.

The clamping parts 10 and 11 are made of bent stainless flat steel, the screw 12 and the associated nut 13 and the end pieces 8 and 9 are also made of stainless steel.

In the illustrated embodiments, the enclosure consists of four set-up panels 1. However, there is also the possibility to expand and, for example, to extend such an enclosure. In this case, two panels 1 can be lined up side by side on one side and the opposite. A containment with six panels 1 is then formed with the two end-facing panels 1. A T-profile is inserted between the two panels 1 lined up side by side in the armpits of which T-profile the vertical outer edges of the panels 1 abut. This T-profile is connected to a pulling means with the opposite T-profile. The T-profiles hold the panels 1 with their two arms on the outside and the weight of the filling material supports the panels 1 on the inside. Extended enclosures can thus be constructed with such T-profiles.

Also, in the illustrated enclosure, the panels 1 are placed on the ground. However, there is also the possibility of placing a second set of panels 1 over it to raise the enclosure. In this case, however, it is advantageous to not place two corner profiles 2 one above the other but to use corner profiles 2 twice as long with two hole floors 5, in order to pull together the enclosure with two ropes 7, each at approximately central panel height.

### Example of an Assembly Guide of the Enclosure According to the Invention:

Prepare several pieces of strong adhesive tape (power tape), each approx. 15 cm in length, place two panels 1 L-shaped with a corner profile 2 in the corner upright on the groundand bond the adhesive strip in the upper region outside around the corner so that it stands by itself. Then place the next corner profile 2 and the next panel 1 and fix the corner again with a prepared adhesive strip. If the closed enclosure is standing, the rope 7 with the arc-shaped end piece 9 in front is threaded successively through the holes 5 of the four corner profiles 2. After that, the clamping parts 10, 11 are pushed just before the end piece with its slot 14 on the rope 7, the two clamping parts 10, 11 are screwed together with the screw 12 and nut 13, so that the rope is tightened. This should be tightened taut. Lastly, fill in soil and remove the adhesive strips glued around the corner.

What is claimed is:

1. An enclosure, having upright panels, wherein upright hollow corner profiles are used to support those at the corners of the enclosure, which have two formed legs on the outside in order to encompass the panels at their vertical outer edges, characterized in that at least one approximately horizontally extending hole for passing through a circumferential pulling means is provided in the corner profile at an inner corner and that the corner profiles are pulled together with this pulling means.

2. The enclosure according to claim 1, characterized in that the inner corner of the hollow corner profile is designed arc-shaped and the holes are provided following the arc in two walls of the inner corner of the hollow profile so that the pulling means can wrap around the arc kink-free.

3. The enclosure according to claim 2, characterized in that at least one of two end pieces attached to the two ends of the pulling means is designed bent.

4. The enclosure according to claim 1, characterized in that two U-shaped clamping parts are used for tensioning the pulling means, which clamping parts are screwed together with a screw and a nut or a thread in one of the two clamping parts.

5. The enclosure according to claim 1, characterized in that the panels are made of porcelain stoneware.

6. The enclosure as in claim 1, wherein the enclosure is a plant container, a raised bed, or a flower box.
